(19) United States
(12) Patent Application Publication
(10) Pub. No.: US 2017/0110261 A1
(43) Pub. Date: Apr. 20, 2017

(54) ELECTROLYTE AND ELECTROCHEMICAL DEVICE

(71) Applicant: DAIKIN INDUSTRIES, LTD., Osaka-shi, Osaka (JP)

(72) Inventor: Kenzou TAKAHASHI, Settsu, Osaka (JP)

(73) Assignee: DAIKIN INDUSTRIES, LTD., Osaka-shi, Osaka (JP)

(21) Appl. No.: 15/128,842

(22) PCT Filed: May 19, 2015
(86) PCT No.: PCT/JP2015/064283

§ 371 Date: Sep. 23, 2016

(30) Foreign Application Priority Data
May 21, 2014 (JP) 2014-105472

(51) Int. Cl. H01G 11/62; H01M 10/0569; H01M 10/0568; H01G 11/60; H01G 11/74

(52) U.S. Cl. CPC H01G 11/62; H01G 11/60; H01G 11/74; H01M 10/0568; H01M 10/0569; H01M 2300/0025

(57) ABSTRACT

The present invention aims to provide an electrolyte solution and an electrochemical device which can keep the initial capacitance and are less likely to increase the internal resistance even after long-term use. An electrolyte solution includes: a tetraalkyl quaternary ammonium salt (A); a heterocyclic ring-containing quaternary ammonium salt (B); and a solvent, the sum of concentrations of the tetraalkyl quaternary ammonium salt (A) and the heterocyclic ring-containing quaternary ammonium salt (B) being 0.6 to 2.1 mol/L, the ratio of the concentration of the tetraalkyl quaternary ammonium salt (A) to the concentration of the heterocyclic ring-containing quaternary ammonium salt (B) (A/B) being 0.015 to 1.000.

### TECHNICAL FIELD

The present invention relates to electrolyte solutions and electrochemical devices including the electrolyte solutions.

### BACKGROUND ART

Electrolyte solutions often used in electrochemical devices such as electric double-layer capacitors are obtained by dissolving, for example, a quaternary ammonium salt in an organic solvent such as a cyclic carbonate (e.g., propylene carbonate) or a nitrile compound (see Patent Literature 1).

For such electrolyte solutions, various methods are studied for improving the characteristics of electrochemical devices.

For example, in order to suppress a decrease in withstand voltage and capacitance of electrochemical devices, the amounts of specific impurities in electrolyte solutions are reduced (see, for example, Patent Literature documents 2 and 3). In order to improve the withstand voltage, a nonaqueous solvent is used including sulfolane or its derivative and a specific acyclic carbonate (see, for example, Patent Literature 4). In order to improve the safety, an electrolyte solution is proposed including a specific electrolyte and a fluorine-containing organic solvent (see, for example, Patent Literature 5).

Patent Literature 6 discloses, as an electrolyte solution used for electric double-layer capacitors workable even at very low temperatures, an electrolyte solution containing a solvent containing acetonitrile and triethylmethylammonium tetrafluoroborate or spirobipyrrolidium tetrafluoroborate as a quaternary ammonium salt.

### CITATION LIST

### Patent Literature

Patent Literature 1: JP 2000-124077 A
Patent Literature 2: JP 2004-186246 A
Patent Literature 3: JP 2000-311839 A
Patent Literature 4: JP H08-306591 A
Patent Literature 5: JP 2001-143750 A
Patent Literature 6: US 2011/0170237

### SUMMARY OF INVENTION

### Technical Problem

However, even if electrochemical devices with a sufficiently high initial capacitance and a sufficiently low initial internal resistance can be formed using conventional electrolyte solutions, the capacitance tends to decrease and the internal resistance tends to increase after long-term use. Therefore, such conventional electrolyte solutions need to be improved.

The present invention is devised in consideration of such a state of the art, and aims to provide an electrolyte solution and an electrochemical device which can keep the initial capacitance and is less likely to increase the internal resistance even after long-term use.

### Solution to Problem

The present inventors found that the above problems can be solved by selecting specific two kinds of quaternary ammonium salts and using these salts in a specific ratio, thereby completing the present invention.

That is, the present invention relates to an electrolyte solution including:

a tetraalkyl quaternary ammonium salt (A);

a heterocyclic ring-containing quaternary ammonium salt (B); and

a solvent,

the sum of concentrations of the tetraalkyl quaternary ammonium salt (A) and the heterocyclic ring-containing quaternary ammonium salt (B) being 0.6 to 2.1 mol/L,

the ratio of the concentration of the tetraalkyl quaternary ammonium salt (A) to the concentration of the heterocyclic ring-containing quaternary ammonium salt (B) (A/B) being 0.015 to 1.000.

The heterocyclic ring-containing quaternary ammonium salt (B) is preferably at least one selected from the group consisting of spirobipyrrolidinium salts, imidazolium salts, N-alkylpyridinium salts, and N,N-dialkylpyrrolidinium salts.

The concentration of the heterocyclic ring-containing quaternary ammonium salt (B) is preferably 0.5 mol/L or more.

The solvent is preferably at least one selected from the group consisting of nitrile compounds, sulfolane compounds, fluorine-containing ethers, cyclic carbonates, and acyclic carbonates.

The solvent preferably contains a nitrile compound.

The electrolyte solution of the present invention is preferably intended for use in electrochemical devices.

The electrolyte solution of the present invention is preferably intended for use in electric double-layer capacitors.

The present invention also relates to an electrochemical device including the electrolyte solution, a positive electrode, and a negative electrode.

The electrochemical device of the present invention is preferably an electric double-layer capacitor.

### Advantageous Effects of Invention

The present invention can provide an electrolyte solution and an electrochemical device which can keep the initial capacitance and are less likely to increase the internal resistance even after long-term use.

### DESCRIPTION OF EMBODIMENTS

The present invention relates to an electrolyte solution including: a tetraalkyl quaternary ammonium salt (A); a heterocyclic ring-containing quaternary ammonium salt (B); and a solvent, the sum of concentrations of the tetraalkyl quaternary ammonium salt (A) and the heterocyclic ring-containing quaternary ammonium salt (B) being 0.6 to 2.1 mol/L, the ratio of the concentration of the tetraalkyl quaternary ammonium salt (A) to the concentration of the heterocyclic ring-containing quaternary ammonium salt (B) (A/B) being 0.015 to 1.000.

Therefore, the electrolyte solution of the present invention can keep the initial capacitance and is less likely to increase the internal resistance even after long-term use.

The electrolyte solution of the present invention includes a tetraalkyl quaternary ammonium salt (A) and a heterocyclic ring-containing quaternary ammonium salt (B).

The reason why the electrolyte solution of the present invention can give the above durability to electrochemical devices is not completely clear, but is presumed as follows based on the results of studies conducted by the present inventors.

The use of a heterocyclic ring-containing quaternary ammonium salt among conventionally used quaternary ammonium salts can provide an electrochemical device with a high initial capacitance and a low internal resistance. However, deterioration of the electrochemical device is unavoidable due to continuous use thereof. Such deterioration is presumably caused by moisture, particularly hydroxide ions, slightly contained in an electrolyte solution. In an electrolyte solution containing a quaternary ammonium salt having chain cations, such as a tetraalkyl quaternary ammonium salt, a hydroxide ion reacts with the chain cation. In contrast, in a heterocyclic ring-containing quaternary ammonium salt, a cation is constituted by a heterocyclic ring, and static charge is shielded. Therefore, hydroxide ions are less likely to be attracted to the heterocyclic ring-containing quaternary ammonium salt. Accordingly, hydroxide ions preferentially react with the quaternary ammonium salt having chain cations. In such a case, the heterocyclic ring-containing quaternary ammonium salt is less likely to be adversely affected by hydroxide ions. Therefore, excellent initial characteristics provided by the heterocyclic ring-containing quaternary ammonium salt is presumably kept for a long time.

This is nothing more than a presumption making the present invention easy to understand, and the present invention is not limited only to the above mechanism.

The tetraalkyl quaternary ammonium salt (A) is preferably one represented by the formula (A):

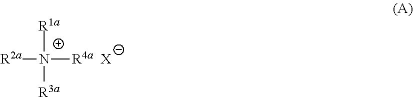

wherein R^{1a}, R^{2a}, R^{3a}, and R^{4a} are the same as or different from each other and each represent a C1-C6 alkyl group optionally containing an ether bond; and X⁻ represents an anion.

In order to improve the oxidation resistance, part or all of the hydrogen atoms in the ammonium salt is/are also preferably replaced by a fluorine atom and/or a C1-C4 fluorine-containing alkyl group.

R^{1a}, R^{2a}, R^{3a}, and R^{4a} in the formula (A) are the same as or different from each other and each represent a C1-C6 alkyl group optionally containing an ether bond.

R^{1a}, R^{2a}, R^{3a}, and R^{4a} each preferably have 1 to 4 carbon atoms.

Preferred examples of the C1-C4 alkyl group optionally containing an ether bond include methoxymethyl, methoxyethyl, ethoxymethyl, and ethoxyethyl.

The anion X⁻ may be either an inorganic anion or an organic anion. Examples of the inorganic anion include AlCl₄⁻, BF₄⁻, PF₆⁻, AsF₆⁻, TaF₆⁻, I⁻, and SbF₆⁻. Examples of the organic anion include CF₃COO⁻, CF₃SO₃⁻, (CF₃SO₂)₂N⁻, and (C₂F⁵SO₂)₂N⁻. In particular, in order to achieve good oxidation resistance and ionic dissociation, the anion X⁻ is preferably an inorganic anion, more preferably BF₄⁻, PF₆⁻, AsF₆⁻, or SbF₆⁻.

Specific examples of the tetraalkyl quaternary ammonium salt (A) include those represented by the formula (A-1):

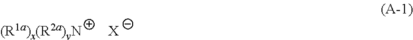

(wherein R^{1a}, R^{2a}, and X⁻ are the same as those mentioned for the formula (A); and x and y are the same as or different from each other, each represent an integer of 0 to 4, and satisfy x+y=4) and alkyl ether group-containing trialkylammonium salts represented by the formula (A-2):

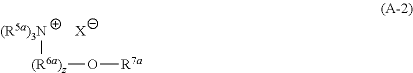

wherein R^{5a} represents a C1-C6 alkyl group; R^{6a} represents a C1-C5 divalent hydrocarbon group; R^{7a} represents a C1-C2 alkyl group; z represents 1 or 2; and X⁻ represents an anion. Introduction of an alkyl ether group may lead to a decrease in viscosity.

Preferred specific examples of the tetraalkyl quaternary ammonium salt (A) include Et₄NBF₄, Et₄NClO₄, Et₄NPF₆, Et₄NAsF₆, Et₄NSbF, Et₄NCF₃SO₃, Et₄N(CF₃SO₂)₂N, Et₄N(C₂F₅SO₂)₂N, Et₃MeNBF₄, Et₃MeNClO₄, Et₃MeNPF₆, Et₃MeNAsF₆, Et₃MeNSbF₆, Et₃MeNCF₃SO₃, Et₃MeN(CF₃SO₂)₂N, and Et₃MeN(C₂FsSO₂)₂N. Particularly preferred are Et₄NBF₄, Et₄NPF₆, Et₄NSbF₆, Et₄NAsF₆, Et₃MeNBF₄, and N,N-diethyl-N-methyl-N-(2-methoxyethyl)ammonium salts.

The heterocyclic ring-containing quaternary ammonium salt (B) is preferably at least one selected from the group consisting of spirobipyrrolidinium salts, imidazolium salts, N-alkylpyridinium salts, and N,N-dialkylpyrrolidinium salts.

The spirobipyrrolidinium salt is preferably a compound represented by the formula (B-1):

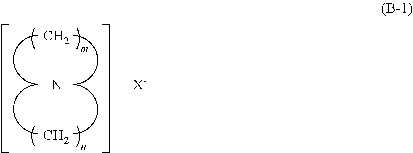

(wherein m and n are the same as or different from each other and each represent an integer of 3 to 7; and X⁻ represents an anion) because such a compound has high solubility, good oxidation resistance, and high ionic conductivity.

In the formula, m and n may be the same as or different from each other and each represent an integer of 3 to 7. In view of the solubility of the salt, they each more preferably represent an integer of 4 or 5.

X⁻ in the formula represents an anion. The anion X⁻ may be either an inorganic anion or an organic anion. Examples of the inorganic anion include AlCl₄⁻, BF₄⁻, PF₆⁻, AsF₆⁻, TaF₆⁻, I⁻, and SbF₆⁻. Examples of the organic anion include CF₃COO⁻, CF₃SO₃⁻, (CF₃SO₂)₂N⁻, and (C₂F₅SO₂)₂N⁻.

In particular, the anion X⁻ is preferably an inorganic anion because it has good oxidation resistance and ionic dissociation, more preferably BF₄⁻, PF₆⁻, AsF₆⁻, or SbF₆⁻. The anion X⁻ is still more preferably BF₄⁻ or PF₆⁻ in view of the solubility of the salt.

In view of the solubility of the salt, the spirobipyrrolidinium salt is specifically preferably any of the following salts:

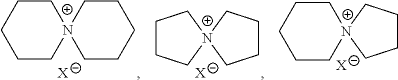

wherein X⁻ represents BF₄⁻ or PF₆⁻.

The imidazolium salt is preferably, for example, one represented by the formula (B-2):

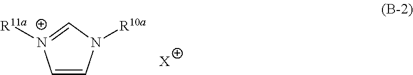

(wherein R^{10a} and R^{11a} are the same as or different from each other and each represent a C1-C6 alkyl group; and X-represents an anion) because it has low viscosity and high solubility. In order to improve the oxidation resistance, part or all of the hydrogen atoms in the imidazolium salt is/are also preferably replaced by a fluorine atom and/or a C1-C4 fluorine-containing alkyl group.

Preferred specific examples of the anion X⁻ are the same as those mentioned for the formula (B-1).

Preferred specific examples of the imidazolium salt include

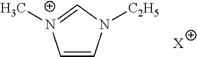

wherein X⁻ represents BF₄⁻, PF₆⁻, AsF₆⁻, or SbF₆⁻.

The N-alkylpyridinium salt is preferably, for example, one represented by the formula (B-3):

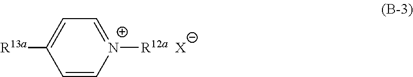

(wherein R^{12a} is a C1-C6 alkyl group; R^{13a} is a hydrogen atom or a methyl group; and X⁻ is an anion) because it has low viscosity and high solubility. In order to improve the oxidation resistance, part or all of the hydrogen atoms in the N-alkylpyridinium salt is/are also preferably replaced by a fluorine atom and/or a C1-C4 fluorine-containing alkyl group.

Preferred specific examples of the anion X⁻ are the same as those mentioned for the formula (B-1).

Those represented by the following formulas:

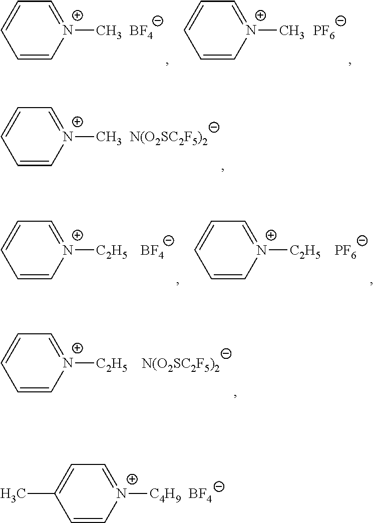

may be mentioned as preferred specific examples of the N-alkylpyridinium salt.

The N,N-dialkylpyrrolidinium salt is preferably, for example, one represented by the formula (B-4):

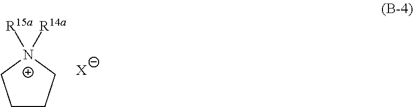

(wherein R^{14a} and R^{15a} are the same as or different from each other and each represent a C1-C6 alkyl group; and X⁻ is an anion) because it has low viscosity and high solubility. In order to improve the oxidation resistance, part or all of the hydrogen atoms in the N,N-dialkylpyrrolidinium salt is/are also preferably replaced by a fluorine atom and/or a C1-C4 fluorine-containing alkyl group.

Further, preferably, R^{4a} and R^{15a} in the formula (B-4) are the same as or different from each other and each represent a C1-C4 alkyl group optionally containing an ether bond.

Preferred examples of the C1-C4 alkyl group optionally containing an ether bond include methoxymethyl, methoxyethyl, ethoxymethyl, and ethoxyethyl.

Preferred specific examples of the anion X⁻ are the same as those mentioned for the formula (B-1).

Those represented by the following formulas:

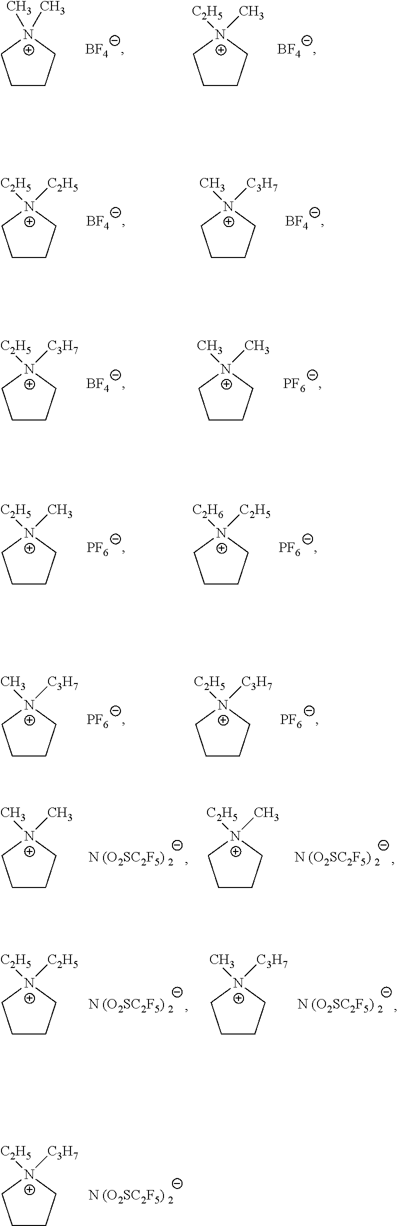

may be mentioned as preferred specific examples of the N,N-dialkylpyrrolidinium salt.

In view of the solubility of the salt, the heterocyclic ring-containing quaternary ammonium salt (B) is more preferably at least one selected from the group consisting of spirobipyrrolidinium salts, imidazolium salts, and N-alkylpyridinium salts. A spirobipyrrolidinium salt and an imidazolium salt are still more preferred.

In the electrolyte solution of the present invention, the sum of concentrations of the tetraalkyl quaternary ammonium salt (A) and the heterocyclic ring-containing quaternary ammonium salt (B) is 0.6 to 2.1 mol/L.

The electrolyte solution with the sum of the concentrations within the above range can keep the initial capacitance and is less likely to increase the internal resistance even after long-term use.

In order to achieve excellent initial characteristics, the sum of the concentrations is preferably 0.7 mol/L or more, more preferably 0.8 mol/L or more, and preferably 1.9 mol/L or less, more preferably 1.8 mol/L or less.

The concentration ratio (A/B) between the tetraalkyl quaternary ammonium salt (A) and the heterocyclic ring-containing quaternary ammonium salt (B) is 0.015 to 1.000.

The electrolyte solution with such a ratio of the concentrations within the above range can keep the initial capacitance and is less likely to increase the internal resistance even after long-term use. The ratio of the concentrations is preferably 0.020 or higher, more preferably 0.025 or higher, and preferably 0.995 or lower, more preferably 0.990 or lower.

In order to achieve excellent initial characteristics, the concentration of the heterocyclic ring-containing quaternary ammonium salt (B) in the electrolyte solution of the present invention is preferably 0.5 mol/L or more, more preferably 0.6 mol/L or more, and preferably 2.0 mol/L or less, more preferably 1.9 mol/L or less.

The electrolyte solution of the present invention contains a solvent.

The solvent preferably contains at least one selected from the group consisting of nitrile compounds, sulfolane compounds, fluorine-containing ethers, cyclic carbonates, and acyclic carbonates. The solvent more preferably contains a nitrile compound.

Examples of the nitrile compound include nitrile compounds represented by the following formula (1):

R¹—(CN)ₙ (1)

wherein R¹ represents a C1-C10 alkyl group or a C1-C10 alkylene group; and n represents an integer of 1 or 2.

If n is 1 in the formula (1), R¹ is a C1-C10 alkyl group. If n is 2, R¹ is a C1-C10 alkylene group.

Examples of the alkyl group include C1-C10 alkyl groups such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, and a decyl group. Preferred among these are a methyl group and an ethyl group.

Examples of the alkylene group include C1-C10 alkylene groups such as a methylene group, an ethylene group, a propylene group, a butylene group, a pentylene group, a hexylene group, an octylene group, a nonylene group, and a decylene group. Preferred among these are a propylene group and an ethylene group.

Specific examples of the nitrile compound include acetonitrile (CH₃—CN), propionitrile (CH₃—CH₂—CN), and glutaronitrile (NC—(CH₂)₃—CN). In order to achieve a low resistance, acetonitrile and propionitrile are preferred.

The amount of the nitrile compound is preferably 50% to 100% by volume in a solvent constituting the electrolyte solution. If the amount thereof falls within the above range, an electric double-layer capacitor can have excellent withstand voltage.

The amount of the nitrile compound is more preferably 60% by volume or more, still more preferably 80% by volume or more, in a solvent constituting the electrolyte solution.

The sulfolane compound may be a fluorine-free sulfolane compound or may be a fluorine-containing sulfolane compound.

Examples of the fluorine-free sulfolane compound include, in addition to sulfolane, fluorine-free sulfolane derivatives represented by the formula (2):

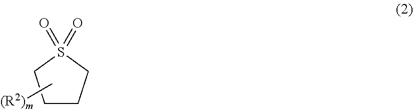

wherein R² represents a C1-C4 alkyl group; and m represents an integer of 1 or 2.

Preferred among these are the following sulfolane and sulfolane derivatives:

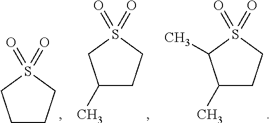

Examples of the fluorine-containing sulfolane compound include the fluorine-containing sulfolane compounds disclosed in JP 2003-132944 A. Those represented by the following formulas:

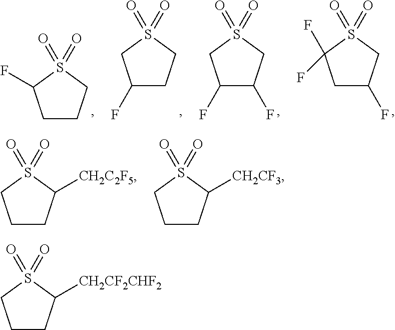

may be mentioned as preferred examples.

Preferred as the above sulfolane compounds are sulfolane, 3-methylsulfolane, and 2,4-dimethylsulfolane, and particularly preferred are sulfolane and 3-methylsulfolane.

Examples of the fluorine-containing ethers include fluorine-containing acyclic ethers and fluorine-containing cyclic ethers.

Examples of the fluorine-containing acyclic ethers include compounds disclosed in JP H08-37024 A, JP H09-97627 A, JP H11-26015 A, JP 2000-294281 A, JP 2001-52737 A, and JP H11-307123 A.

Preferred as the fluorine-containing acyclic ethers are fluorine-containing acyclic ethers represented by the formula (3):

Rf¹—O—Rf² (3)

wherein Rf¹ represents a C1-C10 fluoroalkyl group; and Rf² represents a C1-C4 alkyl group optionally containing a fluorine atom.

A fluorine-containing chain ether in which Rf² in the formula (3) is a fluorine-containing alkyl group is preferred because it has not only particularly better oxidation resistance and compatibility with electrolyte salts, but also a higher decomposition voltage and a lower freezing point that enables maintenance of the low-temperature characteristics as compared with a fluorine-containing acyclic ether in which Rf² is a fluorine-free alkyl group.

Examples of the group for Rf¹ include C1-C10 fluoroalkyl groups such as HCF₂CF₂CH₂—, HCF₂CF₂CF₂CH₂—, HCF₂CF₂CF₂CF₂CH₂—, C₂F₅CH₂—, CF₃CFHCF₂CH₂—, HCF₂CF(CF₃) CH₂—, C₂F₅CH₂CH₂—, and CF₃CH₂CH₂—. Preferred among these are C3-C6 fluoroalkyl groups.

Examples of the group for Rf² include fluorine-free C1-C4 alkyl groups, —CF₂CF₂H, —CF₂CFHCF₃, —CF₂CF₂CF₂H, —CH₂CH₂CF₃, —CH₂CFHCF₃, and —CH₂CH₂C₂F₅. Preferred among these are fluorine-containing C2-C4 alkyl groups.

Particularly preferably, in order to achieve high ionic conductivity, Rf¹ is a C3-C4 fluorine-containing alkyl group and Rf² is a C2-C3 fluorine-containing alkyl group.

The fluorine-containing acyclic ether may be any known one as long as it is applicable to the electrolyte solution. Specific examples thereof include one or two or more of HCF₂CF₂CH₂OCF₂CF₂H, CF₃CF₂CH₂OCF₂CF₂H, HCF₂CF₂CH₂OCF₂CFHCF₃, CF₃CF₂CH₂OCF₂CFHCF₃, HCF₂CF₂CH₂OCH₂CFHCF₃, and CF₃CF₂CH₂OCH₂CFHCF₃. In order to maintain the high decomposition voltage and the low-temperature characteristics, HCF₂CF₂CH₂OCF₂CF₂H, HCF₂CF₂CH₂OCF₂CFHCF₃, CF₃CF₂ CH₂OCF₂CFHCF₃, and CF₃CF₂CH₂OCF₂CF₂H1 are particularly preferred.

Those represented by the following formulas:

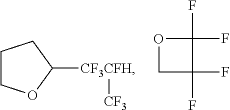

may be mentioned as preferred examples of the fluorine-containing cyclic ethers.

The cyclic carbonate may be a fluorine-free cyclic carbonate or may be a fluorine-containing cyclic carbonate.

Examples of the fluorine-free cyclic carbonate include ethylene carbonate (EC), propylene carbonate (PC), and vinylene carbonate. In order to reduce the internal resistance and maintain the low-temperature characteristics, propylene carbonate (PC) is preferred.

Examples of the fluorine-containing cyclic carbonate include mono-, di-, tri-, or tetra-fluoroethylene carbonates and trifluoromethyl ethylene carbonate. In order to improve the withstand voltage of the resulting electrochemical device, fluoroethylene carbonate and trifluoromethyl ethylene carbonate are preferred.

The acyclic carbonate may be a fluorine-free acyclic carbonate or a fluorine-containing acyclic carbonate.

Examples of the fluorine-free acyclic carbonate include dimethyl carbonate (DMC), diethyl carbonate (DEC), ethyl methyl carbonate (EMC), methyl isopropyl carbonate (MIPC), ethyl isopropyl carbonate (EIPC), and 2,2,2-trifluoroethyl methyl carbonate (TFEMC). In order to reduce the internal resistance and maintain the low-temperature characteristics, dimethyl carbonate (DMC) is preferred.

Examples of the fluorine-containing acyclic carbonate include fluorine-containing acyclic carbonates represented by the following formula (4-1):

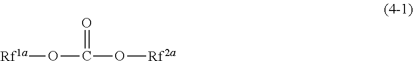

wherein Rf^{1a} represents an alkyl group or a fluoroalkyl group having a moiety represented by the following formula:

(HCX^{2a}X^{2a}

(wherein X^{1a} and X^{2a} are the same as or different from each other and each represent a hydrogen atom or a fluorine atom) at an end and preferably having a fluorine content of 10% to 76% by mass, preferably a C1-C3 alkyl group; and Rf^{2a} represents a fluoroalkyl group having a moiety represented by the above formula or CF₃ at an end and preferably having a fluorine content of 10% to 76% by mass; fluorine-containing acyclic carbonates represented by the following formula (4-2):

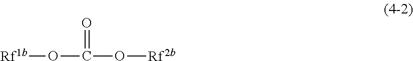

wherein Rf^{2b} represents a fluorine-containing alkyl group having an ether bond and —CF₃ at an end, and having a fluorine content of 10% to 76% by mass; and Rf_{2b} represents a fluorine-containing alkyl group having an ether bond or a fluorine-containing alkyl group, each of which has a fluorine content of 10% to 76% by mass; and fluorine-containing acyclic carbonates represented by the following formula (4-3):

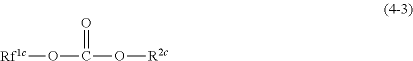

wherein Rf^{1c} represents a fluorine-containing alkyl group having an ether bond and a moiety represented by HCFX^{1c}— (wherein X^{1c} represents a hydrogen atom or a fluorine atom) at an end and having a fluorine content of 10% to 76% by mass; and R^{2c} represents an alkyl group in which a hydrogen atom is optionally replaced by a halogen atom and which optionally has a hetero atom in the chain.

The fluorine content of each fluorine-containing alkyl group (Rf^{2a}, Rf^{1b}, Rf^{2b}, or Rf^{2c}) is a value calculated by the formula {(number of fluorine atoms×19)/(formula weight of each group)}×100(%) based on the corresponding structural formula of each group.

Specific examples of usable fluorine-containing acyclic carbonates preferably include acyclic carbonates having a combination of fluorine-containing groups represented by the following formula (4-4):

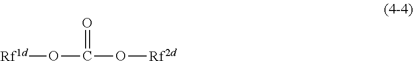

wherein Rf^{1d} and Rf^{2d} each represent H(CF₂)₂CH₂—, FCH₂CF₂CH₂—, H(CF₂)₂CH₂CH₂—, CF₃CF₂CH₂—, CF₃CH₂CH₂—, CF₃CF(CF₃) CH₂CH₂—, C₃F₇OCF(CF₃)CH₂—, CF₃OCF(CF₃)CH₂—, CF₃OCF₂—, or the like.

In order to reduce the internal resistance and maintain the low-temperature characteristics, the fluorine-containing acyclic carbonate is preferably any of the following carbonates:

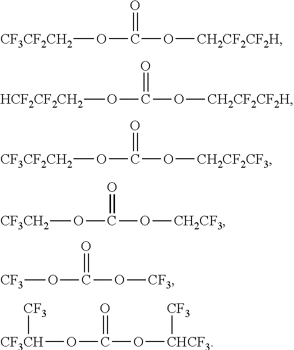

In addition, the fluorine-containing acyclic carbonate may also be any of the following carbonates:

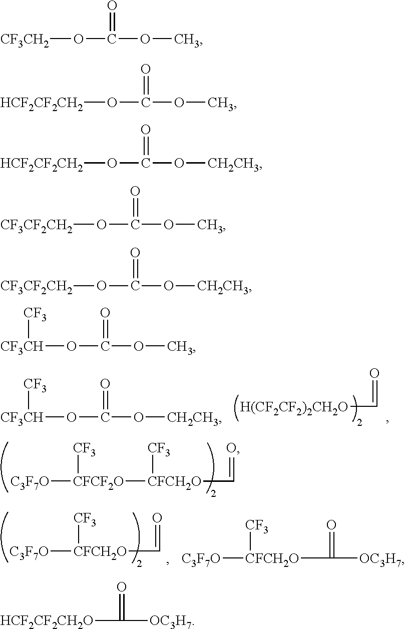

Examples of other solvents to be mixed with the above electrolyte solution include fluorine-free lactones and fluorine-containing lactones represented by the following formulas:

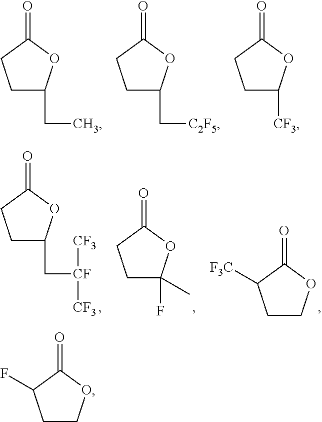

furans, and oxolanes.

When the electrolyte solution contains any of the additional solvents as listed above, the amount of the at least one solvent selected from the group consisting of nitrile compounds, sulfolane compounds, fluorine-containing ethers, cyclic carbonates, and acyclic carbonates is preferably 50% by volume or more, more preferably 60% by volume or more, still more preferably 70% by volume or more, based on the entire solvent.

The amount of the additional solvent in the electrolyte solution is preferably less than 50% by volume, more preferably less than 40% by volume, still more preferably less than 30% by volume.

The electrolyte solution may also contain an additional electrolyte salt.

Such an additional electrolyte salt may be a lithium salt. Preferred examples of the lithium salt include LiPF₆, LiBF₄, LiAsF₆, LiSbF₆, and LiN(SO₂C₂H₅)₂.

In order to further improve the capacitance, a magnesium salt may be used. Preferred examples of the magnesium salt include Mg(ClO₄)₂ and Mg(OOC₂H₅)₂.

The electrolyte solution can be prepared by mixing the tetraalkyl quaternary ammonium salt (A) and the heterocyclic ring-containing quaternary ammonium salt (B) with the solvent and optionally other components and dissolving the salts in the solvents. Mixing and dissolution can be performed by conventionally known method.

Further, the electrolyte solution of the present invention may be a gel electrolyte solution gelled (plasticized) in combination with a polymer material that is soluble or swellable in the nitrile compound.

Examples of such a polymer material include conventionally known polyethylene oxide and polypropylene oxide and modified products thereof (JP H08-222270 A, JP 2002-100405 A); polyacrylate-based polymers, polyacrylonitrile, fluororesins such as polyvinylidene fluoride and vinylidene fluoride-hexafluoropropylene copolymers (JP H04-506726 T, JP H08-507407 T, JP H10-294131 A); and complexes of any of such fluororesins and any of hydrocarbon resins (JP H11-35765 A, JP H11-86630 A). In particular, polyvinylidene fluoride or a vinylidene fluoride-hexafluoropropylene copolymer is preferably used as the polymer material for a gel electrolyte solution.

In addition, an ion-conducting compound disclosed in JP 2006-114401 A may also be used.

The ion-conducting compound is an amorphous fluorine-containing polyether compound having a fluorine-containing group in a side chain and is represented by the formula (5):

P-(D)-Q (5)

wherein D is represented by the formula (6-1):

-(D1)ₙ-(FAE)ₘ-(AE)ₚ-(Y)_{q}- (6-1)

wherein D1 is an ether unit which has a fluorine-containing organic group having an ether bond in a side chain and is represented by the formula (6a):

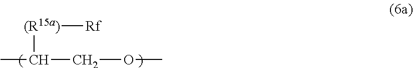

(wherein Rf represents a fluorine-containing organic group having an ether bond and optionally containing a crosslinkable functional group; and R^{15a} represents a group or an atomic bond that couples Rf with the main chain); FAE represents an ether unit which has a fluorine-containing alkyl group in a side chain and is represented by the formula (6b):

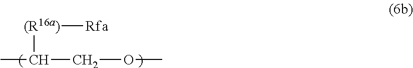

(wherein Rfa represents a hydrogen atom or a fluorine-containing alkyl group optionally containing a crosslinkable functional group; and R^{16a} represents a group or an atomic bond that couples Rfa with the main chain); AE represents an ether unit represented by the formula (6c):

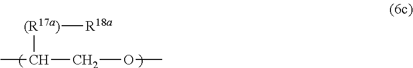

(wherein R^{18a} represents a hydrogen atom, an alkyl group optionally containing a crosslinkable functional group, an alicyclic hydrocarbon group optionally containing a crosslinkable functional group, or an aromatic hydrocarbon group optionally containing a crosslinkable functional group; and R^{17a} represents a group or an atomic bond that couples R^{18a} with the main chain);
Y represents a unit including at least one of the units represented by the formulas (6d-1) to (6d-3):

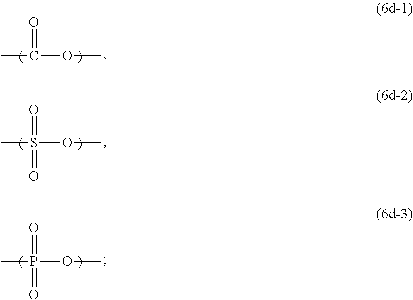

n represents an integer of 0 to 200; m represents an integer of 0 to 200; p represents an integer of 0 to 10000; and q represents an integer of 1 to 100, where n+m is not 0 and the order of bonding of D1, FAE, AE, and Y is not specified; and P and Q are the same as or different from each other and each represent a hydrogen atom, an alkyl group optionally containing a fluorine atom and/or a crosslinkable functional group, a phenyl group optionally containing a fluorine atom and/or a crosslinkable functional group, a —COOH group, —OR^{19a} (wherein R^{19a} represents a hydrogen atom or an alkyl group optionally containing a fluorine atom and/or a crosslinkable functional group), an ester group, or a carbonate group (if a terminal of D is an oxygen atom, neither P nor Q is a COOH group, —OR^{19a}, an ester group, or a carbonate group.

The electrolyte solution of the present invention may contain another additive, if needed. Examples of such an additive include metal oxides and glass. These may be used as long as they do not impair the effects of the present invention.

Preferably, the electrolyte solution of the present invention does not freeze or the electrolyte salt does not precipitate at low temperature (e.g., 0° C., −20° C.). Specifically, the viscosity at 0° C. is preferably 100 mPa's or lower, more preferably 30 mPa's or lower, particularly preferably 15 mPa·s or lower. Further, specifically, the viscosity at −20° C. is preferably 100 mPa·s or lower, more preferably 40 mPa·s or lower, particularly preferably 15 mPa·s or lower.

The electrolyte solution of the present invention is preferably a nonaqueous electrolyte solution.

The electrolyte solution of the present invention is useful as an electrolyte solution of various electrochemical devices including an electrolyte solution. Examples of the electrochemical devices include electric double-layer capacitors, lithium secondary batteries, radical batteries, solar cells (especially, dye sensitized solar cells), fuel cells, various electrochemical sensors, electrochromic elements, electrochemical switching elements, aluminum electrolytic capacitors, and tantalum electrolytic capacitors. In particular, the electrolyte solution of the present invention is suitable for electric double-layer capacitors and lithium secondary batteries, more suitable for electric double-layer capacitors. The electrolyte solution of the present invention is also usable as an ion conductor of antistatic coating materials.

As mentioned above, the electrolyte solution of the present invention is preferably used for electrochemical devices, particularly preferably for electric double-layer capacitors.

An electrochemical device including the electrolyte solution of the present invention, a positive electrode, and a negative electrode is also one aspect of the present invention. Examples of the electrochemical device include those mentioned above, and an electric double-layer capacitor is particularly preferred.

The following will describe in detail a case where the electrochemical device of the present invention is an electric double-layer capacitor.

In the electric double-layer capacitor of the present invention, at least one of the positive electrode or the negative electrode is preferably a polarizable electrode. The polarizable electrode and a non-polarizable electrode may be the following electrodes specifically disclosed in JP H09-7896 A.

The polarizable electrode to be used may mainly include activated carbon, and preferably contains inactive carbon having a large specific surface area and a conducting agent (e.g., carbon black) which imparts electronic conductivity. The polarizable electrode can be formed by various methods. For example, a polarizable electrode including activated carbon and carbon black can be formed by mixing activated carbon powder, carbon black, and a phenolic resin, press-molding the mixture, and then firing and activating the mixture in an inert gas atmosphere and in a steam atmosphere. This polarizable electrode is preferably bonded with a current collector using, for example, a conductive adhesive.

Alternatively, a polarizable electrode may be prepared by kneading activated carbon powder, carbon black, and a binder in the presence of an alcohol to form a sheet-shaped mixture, and then drying the sheet-shaped mixture. This binder may be polytetrafluoroethylene, for example. Alternatively, a polarizable electrode integrated with a current collector may be formed by mixing activated carbon powder, a conductive agent (e.g., carbon black), a binder, and a solvent to form slurry, applying this slurry to a metal foil of a current collector, and drying the applied slurry.

Both electrodes of the electric double-layer capacitor may be polarizable electrodes mainly including activated carbon. Further, the electric double-layer capacitor may have a structure in which one electrode is a non-polarizable electrode. Examples of such a structure include a structure in which a positive electrode mainly includes a cell active material such as a metal oxide and a negative electrode is a polarizable electrode mainly including activated carbon; and a structure in which a negative electrode includes metallic lithium or a lithium alloy and a polarizable electrode mainly includes activated carbon.

In place of or in combination with activated carbon, a carbonaceous material may be used such as carbon black, graphite, expanded graphite, porous carbon, carbon nanotube, carbon nanohorn, or ketjen black.

The solvent to be used for preparation of slurry in the production of an electrode is preferably one that dissolves a binder. The solvent is appropriately selected from N-methylpyrrolidone, dimethylformamide, toluene, xylene, isophorone, methyl ethyl ketone, ethyl acetate, methyl acetate, dimethyl phthalate, ethanol, methanol, butanol, and water in accordance with the type of the binder.

Examples of the activated carbon to be used for polarizable electrodes include phenol resin-based activated carbon, coconut shell-based activated carbon, and petroleum coke-based activated carbon. In order to achieve a large capacitance, coconut shell-based activated carbon is preferred. Further, examples of a method for activating activated carbon include a steam activation method and a molten KOH activation method. In order to achieve a larger capacitance, the use of activated carbon activated by steam activation method is preferred.

Preferred examples of the conducting agent to be used for polarizable electrodes include carbon black, ketjen black, acetylene black, natural graphite, artificial graphite, metal fibers, conductive titanium oxide, and ruthenium oxide. In order to achieve good conductivity (low internal resistance), the amount of the conducting agent (e.g., carbon black) used for polarizable electrodes is preferably 1% to 50% by mass in the sum of the amounts of the conducting agent and the activated carbon. If the amount of the conducting agent is too large, the capacitance of a product may be lowered.

In order to provide an electric double-layer capacitor having a large capacitance and a low internal resistance, the activated carbon used for polarizable electrodes preferably has an average particle size of 20 m or smaller and a specific surface area of 1500 to 3000 m²/g.

The current collector has only to be chemically and electrochemically resistant to corrosion. Preferred examples of the current collector of a polarizable electrode mainly including activated carbon include stainless steel, aluminum, titanium, and tantalum. Particularly preferred materials among these are stainless steel and aluminum in terms of both the characteristics and price of an electric double-layer capacitor to be obtained.

Examples of commonly known electric double-layer capacitors include wound-type electric double-layer capacitors, laminate-type electric double-layer capacitors, and coin-type electric double-layer capacitors. The electric double-layer capacitor of the present invention may be of any of these types.

For example, a wound-type electric double-layer capacitor may be produced as follows: a positive electrode and a negative electrode each having a laminate (electrode) of a current collector and an electrode layer are wound with a separator in between to form a wound element; this wound element is put into a container made of, for example, aluminum; the container is filled with an electrolyte solution; and then the container is sealed with a rubber sealing material.

The separator may be formed from any conventionally known material and may have any conventionally known structure in the present invention. Examples thereof include a polyethylene porous membrane and nonwoven fabric of polypropylene fibers, glass fibers, or cellulose fibers.

Alternatively, by a known method, an electric double-layer capacitor may be prepared in the form of a laminate-type electric double-layer capacitor including sheet-shaped positive and negative electrodes stacked with each other and an electrolyte solution and a separator in between, or a coin-shaped electric double-layer capacitor including positive and negative electrodes fixed in a coin shape using a gasket and an electrolyte solution and a separator in between.

In cases where the electrochemical device of the present invention is a device other than electric double-layer capacitors, the structure of the device is not limited and a conventionally known structure may be used as long as the electrolyte solution used therein is the electrolyte solution of the present invention.

### EXAMPLES

The following will describe the present invention referring to, but not limited to, examples and comparative examples.

### Example 1

To acetonitrile was added spirobipyrrolidinium tetrafluoroborate (SBP-BF₄) so as to have a concentration of 0.9 mol/L and tetraethylammonium tetrafluoroborate (TEABF₄) so as to have a concentration of 0.1 mol/L. Thus, an electrolyte solution was prepared.

Using the resulting electrolyte solution, an electric double-layer capacitor was produced by the method described below. The resulting electric double-layer capacitor was evaluated for the capacitance retention ratio and the internal resistance increase rate. The results are shown in Table 1.

### (Production of Electrode)

### (Preparation of Slurry for Electrode)

First, 100 parts by weight of coconut shell-based steam-activated carbon (YP50F, Kuraray Chemical Co., Ltd.), 3 parts by weight of acetylene black (DENKA BLACK, Denki Kagaku Kogyo K.K.) as a conductive agent, 2 parts by weight of ketjen black (carbon ECP600JD, Lion Corp.), 4 parts by weight of an elastomer binder, 2 parts by weight of PTFE (POLYFLON PTFE D-210C, Daikin Industries, Ltd.), and a surfactant (trade name: DN-800H, Daicel Corp.) were mixed to provide slurry for electrodes.

Edged aluminum (20CB, Japan Capacitor Industrial Co., Ltd.) was prepared as a current collector. To one face of this current collector was applied the slurry for electrodes using a coating device, and thus an electrode layer (thickness: 100 μm) was formed. Thereby, an electrode was produced.

### (Production of Laminate Cell Electric Double-Layer Capacitor)

The electrode was cut into a predetermined size (20×72 mm). An electrode lead was welded to the aluminum surface of the current collector, and a separator (TF45-30, Nippon Kodoshi Corp.) was inserted between electrodes. The workpiece was put into a laminate case (product No. D-EL40H, Dai Nippon Printing Co., Ltd.). An electrolyte solution was filled into the case and the workpiece was impregnated therewith in a dry chamber. Then, the case was sealed, and thereby a laminate cell electric double-layer capacitor was produced.

### <Capacitance Retention Ratio, Internal Resistance Increase Rate>

The laminate cell electric double-layer capacitor was put into a thermostat chamber at a temperature of 65° C. The capacitance and the internal resistance were measured by applying a voltage of 3.0 V for 1000 hours. The measurement timings were initial (0 hours), 500 hours, and 1000 hours after the start of the measurement. Based on the measured values, the capacitance retention ratio (%) and the internal resistance increase rate were calculated by the following formula.

Capacitance retention ratio (%)=(capacitance at each timing/capacitance before evaluation (initial capacitance))×100

Internal resistance increasing rate=(internal resistance at each timing/internal resistance before evaluation (initial internal resistance)).

### Examples 2 to 8 and Comparative Examples 1 to 13

An electrolyte solution was prepared in the same manner as in Example 1 except that an electrolyte salt(s) was/were added to acetonitrile at a concentration(s) shown in Tables 1 and 2. Then, a laminate cell electric double-layer capacitor was prepared, and the capacitance retention ratio and the internal resistance increase rate thereof were measured. The results are shown in Tables 1 and 2. The abbreviations shown in the tables represent the following.

SBP-BF₄: spirobipyrrolidinium tetrafluoroborate
EMI-BF₄: 1-ethyl-3-methyl imidazolium tetrafluoroborate
TEABF₄: tetraethylammonium tetrafluoroborate
TEMABF₄: triethylmethylammonium tetrafluoroborate
DEMEBF₄: N,N-diethyl-N-methyl-N-(2-methoxyethyl)ammonium tetrafluoroborate

TABLE 1

| | Example 1 | Example 2 | Example 3 | Example 4 | Example 5 | Example 6 | Example 7 | Example 8 |
|---|---|---|---|---|---|---|---|---|
| SBP-BF₄ | 0.9M | 0.9M | 0.9M | — | — | — | — | 0.5M |
| EMI-BF₄ | — | — | — | 2.0M | 2.0M | 2.0M | — | — |
| 1-Butyl- | — | — | — | — | — | — | 0.7M | — |
| 4-methylpyridinium | | | | | | | | |
| tetrafluoroborate | | | | | | | | |
| TEABF₄ | 0.1M | — | — | 0.03M | — | — | — | 0.1M |
| TEMABF₄ | — | 0.1M | — | — | 0.03M | — | — | — |
| DEMEBF₄ | — | — | 0.1M | — | — | 0.03M | 0.7M | — |
| Acetonitrile | 100% | 100% | 100% | 100% | 100% | 100% | 100% | 100% |
| Initial characteristics | 3.7 | 3.7 | 3.7 | 3.9 | 3.9 | 3.9 | 3.9 | 3.1 |
| (Capacitance (F)) | | | | | | | | |
| Capacitance retention ratio (%) | | | | | | | | |
| 0 h | 100 | 100 | 100 | 100 | 100 | 100 | 100 | 100 |
| 500 h | 88 | 89 | 90 | 84 | 85 | 86 | 83 | 90 |
| 1000 h | 86 | 87 | 88 | 82 | 83 | 84 | 81 | 88 |
| Internal resistance (mΩ) | 122 | 122 | 122 | 135 | 135 | 135 | 140 | 200 |
| Internal resistance increase rate | | | | | | | | |
| 0 h | 1.0 | 1.0 | 1.0 | 1.0 | 1.0 | 1.0 | 1.0 | 1.0 |
| 500 h | 1.2 | 1.2 | 1.1 | 1.4 | 1.3 | 1.2 | 1.3 | 1.1 |
| 1000 h | 1.4 | 1.3 | 1.2 | 1.5 | 1.4 | 1.3 | 1.4 | 1.1 |

TABLE 2

| | Comp. | Comp. | Comp. | Comp. | Comp. | Comp. | Comp. | Comp. | Comp. | Comp. | Comp. | Comp. | Comp. |
|---|---|---|---|---|---|---|---|---|---|---|---|---|---|
| | Exam- | Exam- | Exam- | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 7 | ple 8 | ple 9 | ple 10 | ple 11 | ple 12 | ple 13 |
| SBP-BF₄ | 0.9M | — | — | — | — | 0.5M | — | — | — | — | 0.5M | 0.45M | — |
| EMI-BF₄ | — | — | — | — | 2.0M | — | — | — | 2.0M | — | — | — | 2.0M |
| 1-Butyl- | — | — | — | — | — | — | 0.7M | — | — | — | — | — | — |
| 4-methylpyridinium | | | | | | | | | | | | | |
| tetrafluoroborate | | | | | | | | | | | | | |
| TEABF4₄ | — | 0.03M | — | — | — | — | — | — | — | 0.9M | 0.6M | 0.05M | 0.2M |
| TEMABF₄ | — | — | 0.03M | — | — | — | — | — | — | — | — | — | — |
| DEMEBF₄ | — | — | — | 0.03M | — | — | — | 0.7M | 0.01M | — | — | — | — |
| Acetonitrile | 100% | 100% | 100% | 100% | 100% | 100% | 100% | 100% | 100% | 100% | 100% | 100% | 100% |
| Initial characteristics | 3.7 | Not | Not | Not | 3.9 | 3.0 | 3.8 | 2.8 | 3.9 | 3.6 | 3.2 | 3.1 | 3.9 |
| (Capacitance (F)) | | worked | worked | worked | | | | | | | | | |
| Capacitance retention | | | | | | | | | | | | | |
| ratio (%) | | | | | | | | | | | | | |
| 0 h | 100 | | | | 100 | 100 | 100 | 100 | 100 | 100 | 100 | 100 | 100 |
| 500 h | 86 | | | | 81 | 88 | 80 | 80 | 83 | 80 | 87 | 88 | 80 |
| 1000 h | 71 | | | | 66 | 73 | 70 | 60 | 68 | 60 | 72 | 73 | 70 |
| Internal resistance | 122 | Not | Not | Not | 135 | 210 | 140 | 250 | 135 | 135 | 184 | 210 | 140 |
| (mΩ) | | worked | work | worked | | | | | | | | | |
| Internal resistance | | | | | | | | | | | | | |
| increase rate | | | | | | | | | | | | | |
| 0 h | 1.0 | | | | 1.0 | 1.0 | 1.0 | 1.0 | 1.0 | 1.0 | 1.0 | 1.0 | 1.0 |
| 500 h | 1.3 | | | | 1.5 | 1.2 | 1.4 | 1.7 | 1.5 | 1.6 | 1.3 | 1.2 | 1.4 |
| 1000 h | 2.1 | | | | 2.3 | 1.2 | 2.2 | 2.3 | 2.3 | 2.4 | 2.3 | 1.2 | 2.2 |

### INDUSTRIAL APPLICABILITY

The electrolyte solution of the present invention can be used as an electrolyte solution for electrochemical devices such as electric double-layer capacitors.

1. An electrolyte solution comprising:
a tetraalkyl quaternary ammonium salt (A);
a heterocyclic ring-containing quaternary ammonium salt (B); and
a solvent,
the sum of concentrations of the tetraalkyl quaternary ammonium salt (A) and the heterocyclic ring-containing quaternary ammonium salt (B) being 0.6 to 2.1 mol/L,
the concentration ratio (A/B) between the tetraalkyl quaternary ammonium salt (A) and the heterocyclic ring-containing quaternary ammonium salt (B) being 0.015 to 1.000.

2. The electrolyte solution according to claim 1,
wherein the heterocyclic ring-containing quaternary ammonium salt (B) is at least one selected from the group consisting of spirobipyrrolidinium salts, imidazolium salts, N-alkylpyridinium salts, and N,N-dialkylpyrrolidinium salts.

3. The electrolyte solution according to claim 1,
wherein the concentration of the heterocyclic ring-containing quaternary ammonium salt (B) is 0.5 mol/L or more.

4. The electrolyte solution according to claim 1,
wherein the solvent is at least one selected from the group consisting of nitrile compounds, sulfolane compounds, fluorine-containing ethers, cyclic carbonates, and acyclic carbonates.

5. The electrolyte solution according to claim 1,
wherein the solvent contains a nitrile compound.

6. The electrolyte solution according to claim 1, which is intended for use in electrochemical devices.

7. The electrolyte solution according to claim 1, which is intended for use in electric double-layer capacitors.

8. An electrochemical device comprising the electrolyte solution according to claim 1, a positive electrode, and a negative electrode.

9. The electrochemical device according to claim 8, which is an electric double-layer capacitor.
